(19) United States
(12) Patent Application Publication
(10) Pub. No.: US 2006/0101818 A1
(43) Pub. Date: May 18, 2006

(54) BLEED TEC

(76) Inventor: RICHARD DEAN BLACK, HAYWARD, CA (US)

Correspondence Address: RICHARD DEAN BLOCK, 24323 WILLIMET WAY, HAYWARD, CA, 94544, US

(21) Appl. No.: 10/908,288

(22) Filed: May 5, 2005

Related U.S. Application Data
(60) Provisional application No. 60/580,620, filed on Jun. 16, 2004.

(51) Int. Cl. B60T 11/30

(52) U.S. Cl. 60/584

(57) ABSTRACT

Bleed Tec has two L shaped bracket ends with a one by one cut on one plain of each bracket. One adjustment rod, one housing for adjustment rod (two 2″×4″ aluminum cylinders welded together, one with 0.650″ bore thru, and one with side and end threads). Bleed Tec uses one air-cylinder (2″ diameter cylinder 14″ length 9″ ram or stroke that's fitted with ⅛″ air hose quick couple. One eight foot long×⅛″ inner diameter Air supply hose, one three way push button valve that's fitted with a ⅛″ air quick couple.

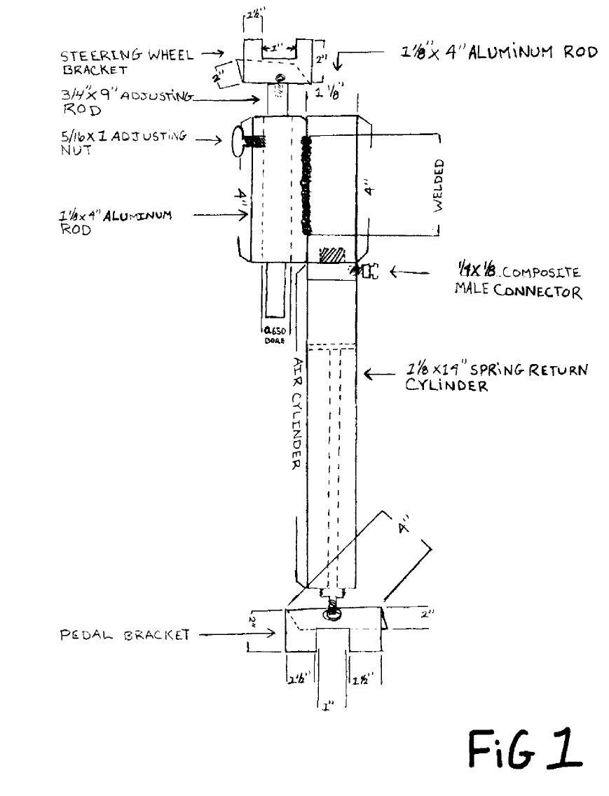

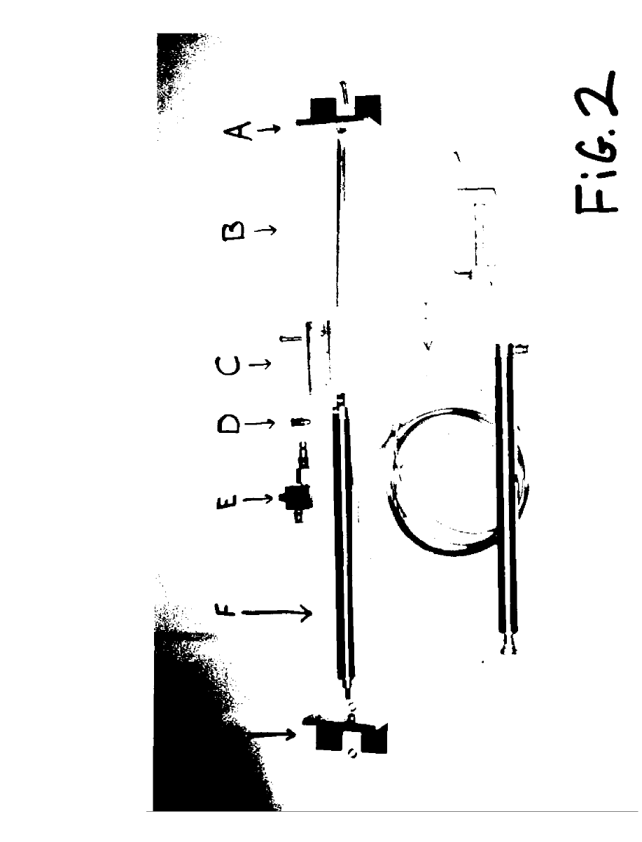

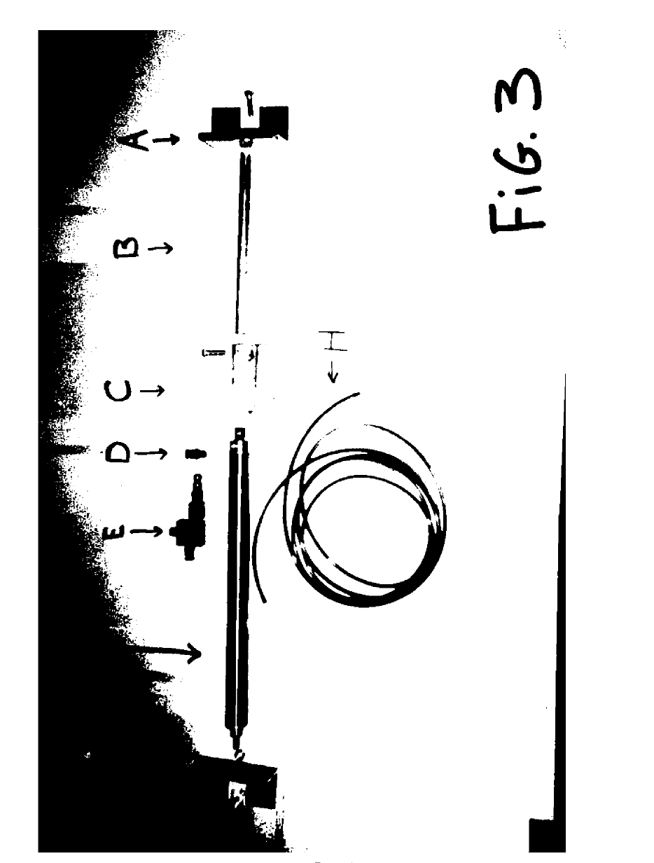

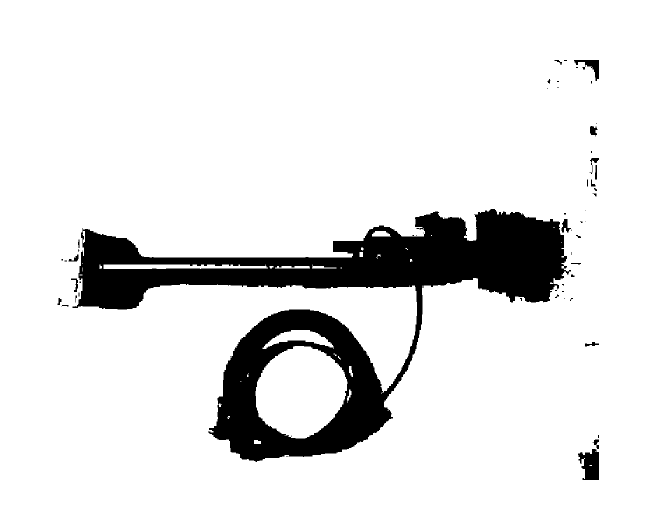

This invention is directed to tools for bleeding, flushing hydraulic brake systems on automobiles. This tool is more concerned with a speedy and more efficient way to bleed or flush hydraulic brake systems.

### OBJECTS AND SUMMARY OF INVETION

Accordingly it is the object to provide a unique tool that is simple to use and relatively inexpensive to manufacture, and which facilitates hydraulic brake bleeding and brake flushing.

What is claimed is:

1. A brake bleeder tool (Bleed Tec) for depressing an auto mobiles brake pedal and releasing the brake pedal via mounting between the brake pedal and the steering wheel of a automobile, in which the body uses a air cylinder with a internal return spring that is actuated by an ⅛ air hose that connects between the air cylinder and a Three-way air valve and each end uses L shape brackets for attachment to the steering wheel and brake pedal, one end has an adjustable extension that screws on the top portion of the cylinder for compensation for the brake pedal and steering wheel distance of different vehicles, solely for the purpose of bleeding air out of the system of an automobiles hydraulic brake or clutch system.

2. The brake bleeder according to claim 1 wherein said extension means two aluminum cylinders each 2″ diameter and 4″ length welded together, one cylinder 0.650″ bore thru and one has threaded end for attaching to air-cylinder end.

3. The brake bleeder according to claim 1 wherein said air-cylinder means 2″ diameter cylinder 14″ length 9″ stroke with spring return.

4. The brake bleeder according to claim 1 wherein said L shape brackets means ¼″ thick aluminum L shaped with a 1″×1″ cut on one plain.

5. The brake bleeder according to claim 1 wherein said three way air valve means a valve used to direct air from one source to another (air cylinder) by way of switch.
